(19) United States
(12) Patent Application Publication
(10) Pub. No.: US 2026/0062047 A1
(43) Pub. Date: Mar. 5, 2026

(54) SENSING STEERING WHEEL

(71) Applicant: PIXART IMAGING INC., HSIN-CHU (TW)

(72) Inventors: YU-SHENG LIN, HSIN-CHU (TW); CHIN-HUA HU, HSIN-CHU (TW); YU-HAN CHEN, HSIN-CHU (TW)

(21) Appl. No.: 18/816,007

(22) Filed: Aug. 27, 2024

(51) Int. Cl. B62D 1/04; B60R 16/027; B62D 1/06

(52) U.S. Cl. CPC B62D 1/046; B60R 16/027; B60R 21/01552; B62D 1/06; B60Y 2400/308

(57) ABSTRACT

A sensing steering wheel includes a wheel handle and a sensor. The sensor is retractably sleeving onto the wheel handle, and the sensor includes an elastic conductive substrate and an elastic sensing layer. The elastic sensing layer is disposed on the elastic conductive substrate, and the elastic sensing layer includes a plurality of sensing lines and a plurality of sensing patterns connected to the plurality of sensing lines, respectively.

### FIELD OF THE DISCLOSURE

The present disclosure relates to a steering wheel, and more particularly to a sensing steering wheel capable of reducing costs.

### BACKGROUND OF THE DISCLOSURE

In the current design of flexible sensor layers, the base material is non-conductive, which necessitates a complex double-sided printing process to create required conductive layers. Initially, silver paste is printed on one side of the base material and then baked to harden. Subsequently, the silver paste is printed on the other side.

However, the base material may contract during the baking process, leading to inaccuracies when printing the silver paste on the other side of the base material. Therefore, the overall production yield may be lowered accordingly.

### SUMMARY OF THE DISCLOSURE

In response to the above-referenced technical inadequacies, the present disclosure provides a sensing steering wheel capable of reducing the cost and steps of manufacturing processes, and improving yield rates for an elastic sensor layer.

In order to solve the above-mentioned problems, one of the technical aspects adopted by the present disclosure is to provide a sensing steering wheel, including a wheel handle and a sensor. The sensor is retractably sleeving onto the wheel handle, and the sensor includes an elastic conductive substrate and an elastic sensing layer. The elastic sensing layer is disposed on the elastic conductive substrate, and the elastic sensing layer includes a plurality of sensing lines and a plurality of sensing patterns connected to the plurality of sensing lines, respectively.

In order to solve the above-mentioned problems, another one of the technical aspects adopted by the present disclosure is to provide a sensing steering wheel, including a wheel handle and a sensor. The sensor is retractably sleeving onto the wheel handle, and the sensor includes an elastic conductive substrate, an isolation layer and an elastic sensing layer. The elastic conductive substrate is conductive and has a plurality of sensor regions, one or more first gaps are disposed among the plurality of sensor regions, and each of the one or more first gaps is arranged to separate adjacent ones of the sensor regions from one another. The isolation layer is disposed on the elastic conductive substrate. The elastic sensing layer is disposed on the isolation layer. The elastic sensing layer includes a plurality of sensing lines and a plurality of sensing patterns. The one or more first gaps are arranged for leading out the plurality of sensing lines. The plurality of sensing patterns are connected to the plurality of sensing lines, respectively.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a top view of a sensing steering wheel according to one embodiment of the present disclosure;

FIG. 2 is a part cross-sectional view of the sensing steering wheel according to one embodiment of the present disclosure;

FIG. 3 is a schematic cross-sectional view of the sensor according to one embodiment of the present disclosure;

FIG. 4 is a top view of the elastic sensing layer according to one embodiment of the present disclosure;

FIG. 5 is a schematic cross-sectional view of the sensor according to another one embodiment of the present disclosure;

FIG. 6 is a top view of the elastic sensing layer according to another one embodiment of the present disclosure; and

FIG. 7 is a schematic exploded view of the sensing steering wheel with a stretched sensor according to yet another one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

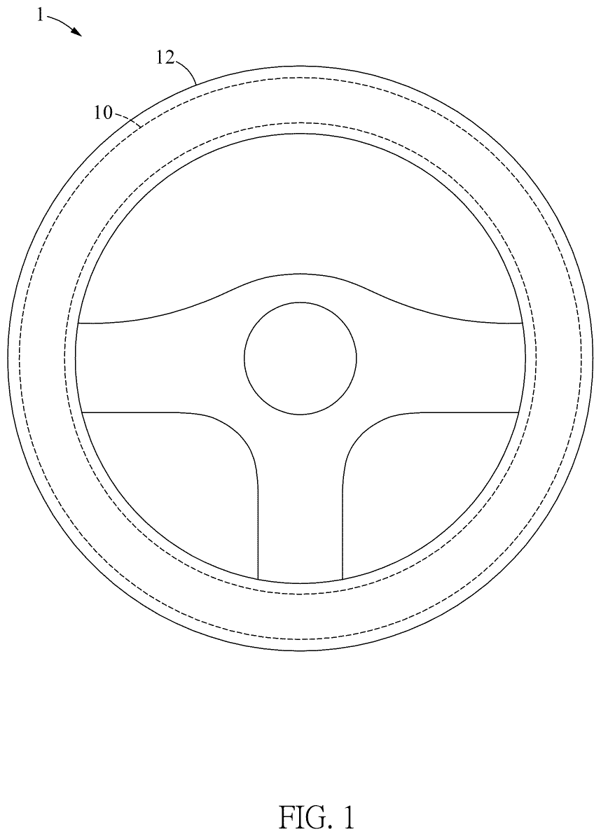

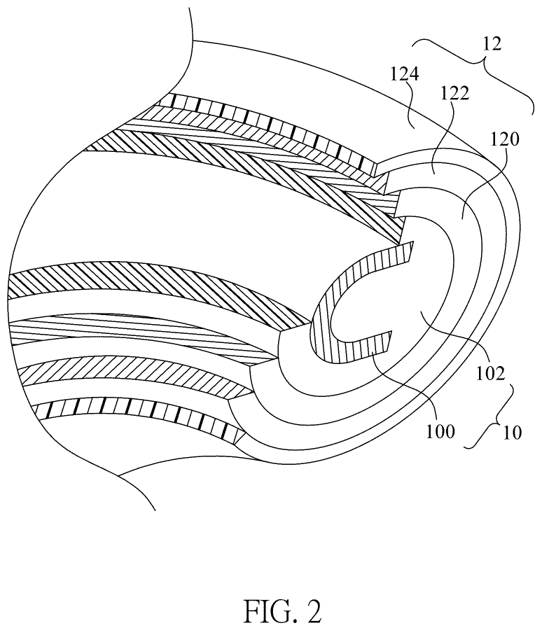

FIG. 1 is a top view of a sensing steering wheel according to one embodiment of the present disclosure, and FIG. 2 is a part cross-sectional view of the sensing steering wheel according to one embodiment of the present disclosure. Referring to FIG. 1, one embodiment of the present disclosure provides a sensing steering wheel 1, which includes a wheel handle 10 and a sensor 12. The sensor 12 retractably sleeves the wheel handle 10.

In the embodiment of FIGS. 1 and 2, the wheel handle 10 can be a wheel ring of the sensing steering wheel 1, and the wheel ring can be connected to a hub at the center of the wheel ring through one or more spokes.

As shown in FIG. 2, the sensing steering wheel 1 is provided with a steering handle 10 and the sensor 12 in an order from the inside to the outside. The steering handle 10 can be annular and include a frame 100 and an inner protective layer 102, and the sensor 12 includes an elastic conductive substrate 120, an isolation layer 122 and an elastic sensing layer 124.

The frame 100 can be made of hard material such as metal or wood, and the inner protective layer 102 can include, for example, a leather layer and/or a foam material layer.

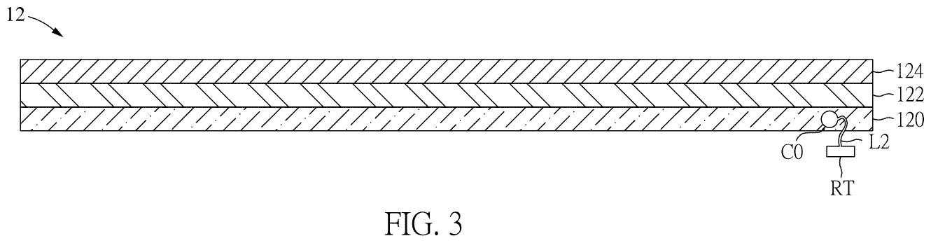

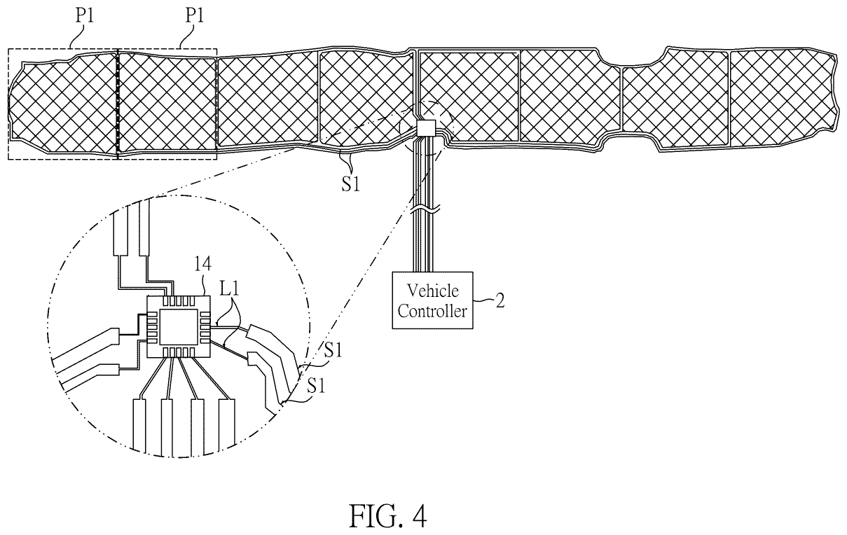

Referring to FIGS. 3 and 4. FIG. 3 is a schematic cross-sectional view of the sensor according to one embodiment of the present disclosure, and FIG. 4 is a top view of the elastic sensing layer according to one embodiment of the present disclosure. As shown in FIG. 3, for convenience of explanation, the sensor 12 is shown as a flat multi-layer structure. In the present embodiment, the isolation layer 122 is disposed between the elastic conductive substrate 120 and the elastic sensing layer 124.

The elastic conductive substrate 120 can be made of an elastic conductive material, which can include, for example, one or more of conductive thermoplastic polyurethane (TPU), conductive silicone, and conductive rubber. It should be noted that the elastic conductive substrate 120 serves as a base material, which means that the isolation layer 122 and the elastic sensing layer 124 can be fabricated on the elastic conductive substrate 120.

Furthermore, the isolation layer 122 can be made of an elastic non-conductive material, which can include, for example, thermoplastic polyurethane (TPU). The isolation layer 122 can be used to provide electrical insulation between the elastic conductive substrate 120 and the elastic sensing layer 124. The isolation layer 122 can be provided with a thickness that is smaller than a thickness of the elastic conductive substrate 120. For example, the thickness of the isolation layer 122 can range from 0% to 10% of the thickness of the elastic conductive substrate 120, or can range from 10% to 20% of the thickness of the elastic conductive substrate 120. The isolation layer 122 can be formed as a film made of TPU, and can be directly attached to an upper surface of the elastic conductive substrate 120.

The elastic conductive substrate 120 and the isolation layer 122 could be integrated as a whole to facilitate following processes for forming the elastic sensing layer 124 and the sensing steering wheel 1. For example, the elastic conductive substrate 120 and the isolation layer 122 can be connected to each other by performing a heat-pressing process.

Moreover, the elastic sensing layer 124 can be formed by printing a conductive material on the isolation layer 122 after the heat-pressing process is performed. The elastic sensing layer 124 can include a plurality of sensing lines S1 and a plurality of sensing patterns P1 connected to the plurality of sensing lines S1, respectively. In this embodiment, each of the sensing patterns P1 has a mesh structure, and the sensing patterns P1 can, for example, jointly form one sensing region, but the present disclosure is not limited thereto. The sensing patterns P1 can be used to form multiple sensing regions, so as to achieve multiple-region hands-off detection.

Since the elastic materials (including conductive one and non-conductive one) are integrated as a base layer to make the sensor 12 stretchable, such that wrinkles can be greatly reduced when sleeving the sensor 12 onto the steering handle 10. Since the substrate (i.e., the elastic conductive substrate 120) is conductive and can be used to provide electrical shielding effect, there is no need to further set an additional shielding layer on another side of the substrate without the elastic sensing layer 124, thereby further reducing wrinkles generated during the process.

Furthermore, the elastic conductive substrate 120 formed of the elastic conductive material also serves as an electrical shielding layer for enhance performance of the elastic sensing layer 124, and there is no need to print the silver paste on both sides of the isolation layer 122. Therefore, manufacturing costs and time can be greatly reduced. In addition, the contracting issue can be avoided, thereby increasing the overall production yield for the sensor 12.

In some embodiments, the sensing steering wheel 1 further includes a processing circuit 14 and a plurality first lead-out lines L1. In detail, the sensing lines S1 and the sensing patterns P1 can be formed by the printing process while reserving an area for arranging the processing circuit 14 (e.g., in a form of a chip). Next, the processing circuit 14 can be disposed on a flexible printed circuit board (FPC) that is disposed in a region on a surface of the wheel handle 10 without the elastic conductive substrate 120. Moreover, the processing circuit 14 can be connected to the sensing lines S1 of the elastic sensing layer 124 through the plurality of first lead-out lines L1.

In some embodiments, the processing circuit 14 can be a processor or a controller, which can be configured to perform a hands-off detection according to the received sensing signals. The sensing signals are generated when the driver touches one or more of the sensing regions on the sensing steering wheel 1.

When the driver's hand comes into contact with one sensing area, it alters the electrical field of that specific area. This change can be detected and converted into the sensing signal. The processing circuit 14 can then interprets these signals to determine which specific sensing area is being touched by the driver. This information can be used for various purposes, such as the hands-off detection, in which the processing circuit 14 can detect if the driver has their hands on the sensing steering wheel 1 or not.

Referring to FIG. 3, one end of a second lead-out line L2 can be electrically connected to the elastic conductive substrate 120, and the other end of the second lead-out line L2 can be connected to a reference terminal RT of the processing circuit 14, such as a ground terminal. Alternatively, the other end of the second lead-out line L2 can be connected to a ground terminal RT provided by the wheel handle. Moreover, each of the second lead-out line L2 can be connected to the elastic conductive substrate 120 through a connection element C0 inserted into the elastic conductive substrate 120, and the connection element C0 can be, for example, a rivet element.

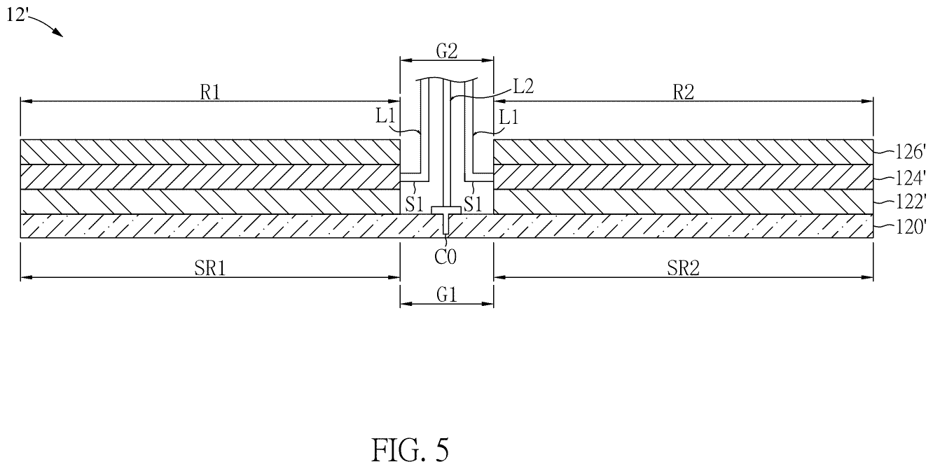

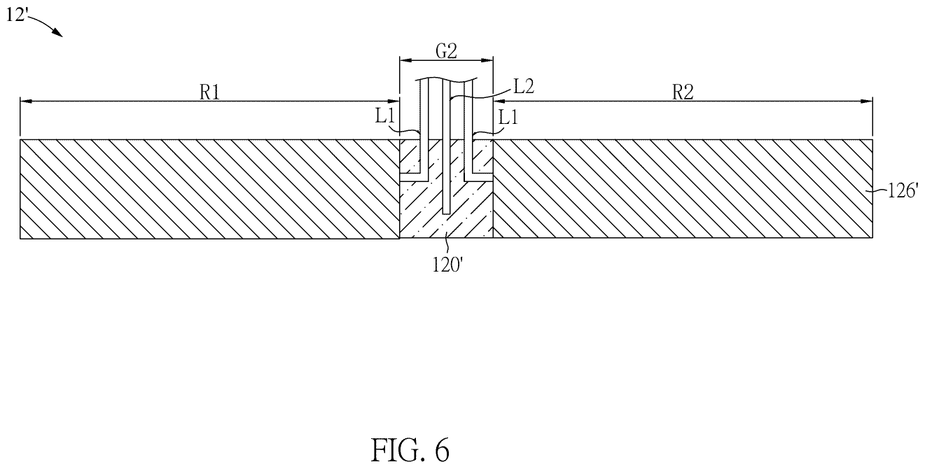

Referring to FIGS. 5 and 6. FIG. 5 is a schematic cross-sectional view of the sensor according to another one embodiment of the present disclosure, and FIG. 4 is a top view of the sensor according to another one embodiment of the present disclosure. As shown in FIG. 5, for convenience of explanation, the sensor 12′ is shown as a flat multi-layer structure. In the present embodiment, the sensor 12′ further includes a protection layer 126′, the isolation layer 122′ is disposed on the elastic conductive substrate 120′, the elastic sensing layer 124′ is disposed on the isolation layer 122′, and the protection layer 126′ is disposed on the elastic sensing layer 124′. The protection layer 126′ can be made of ink, for example, and can provide protection and insulation effects for the elastic sensing layer 124′ to improve its durability.

Furthermore, the elastic conductive substrate 120′ is also conductive in this embodiment, and the elastic conductive substrate 120′ has a plurality of shielding regions, such as shielding regions SR1 and SR2 shown in FIG. 5. A first gap G1 can be arranged between the shielding regions SR1 and SR2. A quantity of the first gap G1 can be one or more, and each first gap G1 can be arrange to separate adjacent ones of the sensor regions from one another. The first gap G1 is arranged to create an area for leading out the sensing lines S1.

In this case, the protection layer 126′, the elastic sensing layer 124′ and the isolation layer 122′ can jointly form a belt structure with a second gap G2. Similar, the elastic sensing layer 124′ has multiple sensing patterns P1 that can form multiple sensing regions, such as sensing regions R1 and R2 shown in FIG. 5. The sensing regions R1 and R2 correspond to the shielding regions SR1 and SR2, respectively, and each second gap G2 can be disposed between the sensing regions R1 and R2.

It should be noted that the second gap G2 is provided for the belt structure formed by the protection layer 126′, the elastic sensing layer 124′ and the isolation layer 122′ to expose a part of the elastic conductive substrate 120′. Similarly, the first lead-out lines L1 can be connected to the sensing lines S1, respectively, and the second lead-out line L2 can be electrically connected to the elastic conductive substrate 120′. Moreover, all of the sensing regions (not only sensing regions R1 and R2) can share the elastic conductive substrate 120, that is, a manner that the sensing regions are arranged in is irrelevant to the shape or structure of the elastic conductive substrate 120.

However, different from the previous embodiment, the first lead-out lines L1 can extend from the sensing lines S1 while passing through the second gap G2, and the second lead-out lines L2 can extend from the exposed part of the elastic conductive substrate 120′ while passing through the second gap G2.

After the first lead-out lines L1 and the second lead-out line L2 extend through the second gap G2, the first lead-out lines L1 can be connected to the processing circuit 14 mentioned above, and the second lead-out line L2 can be connected to the reference terminal of the processing circuit 14 or the wheel handle.

Similar to the previous embodiment, the first lead-out lines L1 can be connected to the sensing lines S1, one end of the second lead-out line L2 can be connected to the reference terminal, and another end of the second lead-out line L2 can be connected to the elastic conductive substrate 120′ through the connection element C0, and the connection element can be a rivet element. The details will not be repeated here.

It should be noted that, since the first gap G1 and the second gap G2 among multiple sensing regions are provided for the elastic sensing layer to expose a part of the shielding layer, space for lead-out lines extend from the sensing lines and the elastic conductive substrate can be created, such that the HOD with multiple region sensing mechanism can be achieved easily.

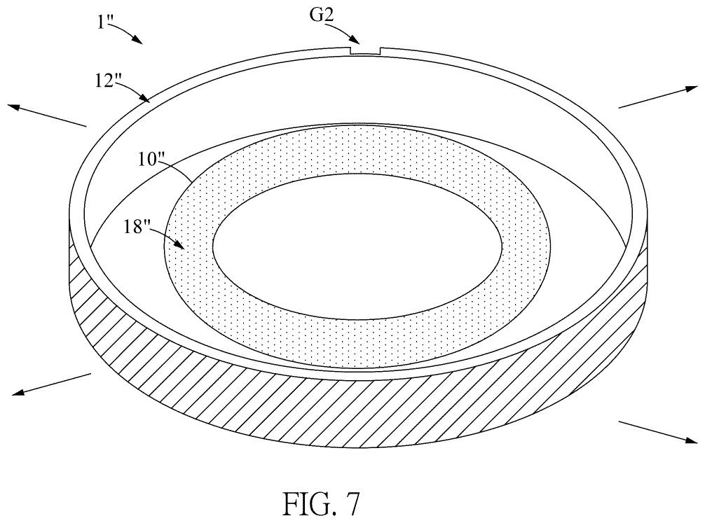

FIG. 7 is an is a schematic exploded view of the sensing steering wheel with a stretched sensor according to yet another one embodiment of the present disclosure. Referring to FIG. 7, a sensor 12″ is provided, in which the protection layer, the elastic sensing layer and the isolation layer jointly form a belt structure with the second gap G2 (which is merely one, for example) on the elastic conductive substrate.

Furthermore, an adhesive layer 18″ can be applied onto a surface of the wheel handle 10″, and the adhesive layer 18″ can be formed by a liquid adhesive material or a double-sided tape.

Moreover, the sensor 12″ can be stretched and retracted to retractably sleeve onto the wheel handle 10″ applied with the adhesive layer 18″, and the adhesive layer 18″ can therefore be disposed between the sensor 12″ and the wheel handle 10″, so as to ensure that the sensor 12″ can be firmly attached to the wheel handle 10″. However, the aforementioned details are disclosed for exemplary purposes only, and are not meant to limit the scope of the present disclosure.

### Beneficial Effects of the Embodiments

In conclusion, in the sensing steering wheel provided by the present disclosure, the elastic conductive substrate, as a base material, can be formed of the elastic conductive material to serve as an electrical shielding layer for enhance performance of the elastic sensing layer, and there is no need to print the silver paste on both sides of the isolation layer, such that manufacturing costs and time can be greatly reduced, and the contracting issue can be avoided, thereby increasing the overall production yield for the sensor.

Furthermore, in the sensing steering wheel provided by the present disclosure, gaps among multiple sensing regions are provided for the elastic sensing layer to expose a part of the shielding layer, which create space for lead-out lines extend from the sensing lines and the elastic conductive substrate, such that the HOD with multiple region sensing mechanism can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A sensing steering wheel, comprising:
a wheel handle; and
a sensor retractably sleeving onto the wheel handle, wherein the sensor includes:
an elastic conductive substrate; and
an elastic sensing layer disposed on the elastic conductive substrate, wherein the elastic sensing layer includes:
a plurality of sensing lines; and
a plurality of sensing patterns connected to the plurality of sensing lines, respectively.

2. The sensing steering wheel according to claim 1, wherein the sensor further includes an isolation layer disposed between the elastic conductive substrate and the elastic sensing layer, and a thickness of the isolation layer is smaller than a thickness of the elastic conductive substrate.

3. The sensing steering wheel according to claim 2, further comprising:
a processing circuit; and
a plurality first lead-out lines connected between the processing circuit and the plurality of sensing lines, respectively,
wherein the elastic sensing layer and the isolation layer jointly form a belt structure with at least one gap that exposes a part of the elastic conductive substrate.

4. The sensing steering wheel according to claim 3, wherein the plurality of first lead-out lines extend from the plurality of sensing lines while passing through the at least one gap; and
wherein the plurality of first lead-out lines are connected to the plurality of sensing lines, respectively.

5. The sensing steering wheel according to claim 4, further comprising at least one second lead-out line each electrically connected between the elastic conductive substrate and a reference terminal of the processing circuit or the wheel handle,
wherein each of the at least one second lead-out line extends from the exposed part of the elastic conductive substrate through the at least one gap.

6. The sensing steering wheel according to claim 5, wherein each of the at least one second lead-out line is connected to the elastic conductive substrate through a connection element, and the connection element is a rivet element.

7. The sensing steering wheel according to claim 2, wherein the sensor further includes a protection layer disposed on the elastic sensing layer, wherein the protection layer, the elastic sensing layer and the isolation layer jointly form the belt structure with at least one gap.

8. The sensing steering wheel according to claim 2, wherein the plurality of sensing patterns jointly form a sensing region.

9. The sensing steering wheel according to claim 2, wherein the elastic sensing layer and the isolation layer jointly form a belt structure with at least one gap that exposes a part of the elastic conductive substrate, the plurality of sensing patterns form a plurality of sensing regions, and the at least one gap is disposed between two of the sensing regions.

10. The sensing steering wheel according to claim 2, wherein the elastic conductive substrate and the isolation layer are connected to each other by performing a heat-pressing process;
wherein the elastic conductive substrate is made of an elastic conductive material, the isolation layer is made of an elastic non-conductive material, and the elastic sensing layer is formed by printing a conductive material on the isolation layer after the heat-pressing process is performed.

11. A sensing steering wheel, comprising:
a wheel handle; and
a sensor retractably sleeving onto the wheel handle, wherein the sensor includes:
an elastic conductive substrate, having a plurality of shielding regions, wherein one or more first gaps are disposed among the plurality of shielding regions, and each of the one or more first gaps is arranged to separate adjacent ones of the sensor regions from one another;
an isolation layer disposed on the elastic conductive substrate; and
an elastic sensing layer disposed on the isolation layer, wherein the elastic sensing layer includes:
a plurality of sensing lines, wherein the one or more first gaps are arranged for leading out the plurality of sensing lines; and
a plurality of sensing patterns connected to the plurality of sensing lines, respectively.

12. The sensing steering wheel according to claim 11, wherein a thickness of the isolation layer is smaller than a thickness of the elastic conductive substrate.

13. The sensing steering wheel according to claim 11, further comprising:
a processing circuit; and
a plurality first lead-out lines connected between the processing circuit and the plurality of sensing lines, respectively, wherein the elastic sensing layer and the isolation layer jointly form a belt structure with one or more second gaps that expose a part of the elastic conductive substrate, and the one or more second gaps are corresponding to the one or more first gaps, respectively.

14. The sensing steering wheel according to claim 13, wherein the plurality of first lead-out lines extend from the plurality of sensing lines while passing through the one or more second gaps; and
wherein the plurality of first lead-out lines are connected to the plurality of sensing lines, respectively.

15. The sensing steering wheel according to claim 14, further comprising at least one second lead-out line each electrically connected between the elastic conductive substrate and a reference terminal of the processing circuit or the wheel handle,
wherein each of the at least one second lead-out line extends from the exposed part of the elastic conductive substrate through the one or more second gaps.

16. The sensing steering wheel according to claim 15, wherein each of the at least one second lead-out line is connected to the elastic conductive layer through a connection element, and the connection element is a rivet element.

17. The sensing steering wheel according to claim 11, wherein the sensor further includes a protection layer disposed on the elastic sensing layer, wherein the protection layer, the elastic sensing layer and the isolation layer jointly form the belt structure with one or more second gaps.

18. The sensing steering wheel according to claim 11, wherein the plurality of sensing patterns jointly form a sensing region.

19. The sensing steering wheel according to claim 11, wherein the elastic sensing layer and the isolation layer jointly form a belt structure with at least one gap that exposes a part of the elastic conductive substrate, the plurality of sensing patterns form a plurality of sensing regions respectively corresponding to the plurality of shielding regions, and each of the one or more second gaps is disposed between two of the sensing regions.

20. The sensing steering wheel according to claim 11, wherein the elastic conductive substrate and the isolation layer are connected to each other by performing a heat-pressing process;
wherein the elastic conductive substrate is made of an elastic conductive material, the isolation layer is made of an elastic non-conductive material, and the elastic sensing layer is formed by printing a conductive material on the isolation layer after the heat-pressing process is performed.
